(19) United States
(12) Patent Application Publication
(10) Pub. No.: US 2026/0208654 A1
(43) Pub. Date: Jul. 23, 2026

(54) APPARATUS AND METHODS FOR DRILLED HOLE LOCATING AND ASSESSING, AND PAYLOAD DELIVERY INTO A HOLE

(71) Applicant: JEVONS IP PTY LIMITED, Hamilton (AU)

(72) Inventor: Andrew Scott VAN DAM, Hamilton (AU)

(21) Appl. No.: 19/141,144

(22) PCT Filed: Dec. 18, 2023
(86) PCT No.: PCT/AU2023/051323

§ 371 Date: Jun. 19, 2025

(30) Foreign Application Priority Data
Dec. 19, 2022 (AU) 2022903891

(51) Int. Cl. B60P 1/56; G05D 1/667; G05D 105/05

(52) U.S. Cl. CPC B60P 1/56; G05D 1/667; G05D 2105/05

(57) ABSTRACT

A mobile platform/vehicle 10 for delivering payload to a drilled hole/blast hole has a hole identification system 70 to identify location of the drilled/blast hole and/or a payload delivery arrangement for controlling delivery of payload material from the payload support structure 12 into the drilled/blast hole. A perception system obtains data relating to hole location, shape, state or angle, which can have an image capture device 72 and/or at least one distance and ranging system. The hole identification system can identify two points within data relating to the hole where difference in distance from one image capture device to each of two points of interest are a maximum for the data. A dipping probe 50 deploys on a flexible elongate member 52 of a winch 56 into the cavity to detect a height or fill level within the blast hole 58.

### TECHNICAL FIELD

One or more embodiments of the present invention relates to apparatus for locating position and/or determining depth of drilled holes in a ground surface, such as for dispensing explosives and/or stemming thereinto.

One or more embodiments of the present invention relates to apparatus and/or method for determining and/or controlling payload delivery into one or more drilled holes, such as explosive into a blast hole.

Hole position locating, hole depth determination and/or amount of explosives and/or stemming to be dispensed or actually dispensed can be provided by a mobile platform or vehicle arranged and configured to traverse a ground surface e.g., terrain, contoured terrain, contoured topography, (any of which may have inclines/declines, elevations and depressions, steep gradients, cross-slopes, holes and/or obstacles (e.g. rocks)), such as at mine sites.

Embodiments of the present invention find application, though not solely, as a mobile platform or vehicle for transporting/delivering explosive to a drill hole/blast hole for blasting in mining operations, such as to aid in the process of blasting to fragment mining benches for the recovery of ore/minerals.

### BACKGROUND

Rock blasting with explosives is often used for fragmenting rock to make ore/minerals embedded in the rock accessible for transport and subsequent processing.

Typically, a blasting plan is developed based on the location of the mine, the prevailing topography, geo-mechanical properties of the rock to be blasted.

Holes are drilled into the rock following completion of the rock blasting plan. Subsequently, explosives and stemming are dispensed into the holes in accordance with the blasting plan. The type and amount of explosive, and any stemming, in a drilled hole forms part of the blasting plan. The stemming is any packing or buffering material, such as earth or crushed rock, used to enclose over the explosive charge in the hole.

ANFO is a commonly used explosive in mine blasting operations. ANFO can be provided as a compound made from ‘prilled’ (pelletised) Ammonium Nitrate (AN) and fuel oil (FO). ANFO is a slurry-like, free flowing explosive; formulated to ensure the appropriate oxygen balance providing optimal energy and sensitivity.

Currently, deposition of explosives (such as ANFO or explosive emulsion) into the drilled holes is often performed manually. The explosives are taken from a safe store and accompanied to the area to be blasted. Operators check the network of drilled holes by manually measuring the hole depth with a tape (aka ‘dipping’), and also check for the presence of any water in the hole by checking the sound emanating from the hole when the distal end of the tape end contacts the bottom of the drilled hole or by inspecting the distal end of the tape after dipping.

The manual process of deposition of explosives has numerous personal safety risks, such as exposing personnel to manually handling explosives and the associated human error risk of mishandling or coming into direct skin contact with the explosives, or personnel not being at a sufficient safe distance when explosives ignite. Economic and commercial realities, such as the remote location of mine sites, dictate that there are often difficulties in recruiting and retaining personnel to perform blast hole activities.

When personnel are involved in blasting activities, unstable ground conditions can result in injury or even death due to accidents or misadventure.

Techniques involving semi-automated vehicles configured for deposition of explosives in holes have been considered. However, such techniques are not completely independent of the human factor and may not exhibit acceptable levels of efficiency, quality and predictability of results.

For example, published patent document U.S. Pat. No. 8,950,330 discusses a common type of truck with standard truck chassis and suspension arrangement and configured to load detonation holes with explosives. The truck comprises a tank, a mixing shovel, a feed tube and a control system. The tank is configured to store the explosive material during transportation and loading of the detonation hole, and the feed tube allows the positioning of its free end over the detonation hole, allowing the explosive material to be deposited within the detonation hole after it passes through the feed pipe. The truck shown in U.S. Pat. No. 8,950,330 contains a control for handling the feed tube, arranged inside the vehicle cabin. However, in spite of comprising a feed tube control device, the mentioned device is driven by a human operator, and not automatically, and the standard truck structure is not specifically configured to negotiate unusual or difficult terrain, such as rocky inclines and cross slopes. Also, although the arrangement disclosed in U.S. Pat. No. 8,950,330 allows some distance between the operator and the explosive charge, such distance is absolutely ineffective in an explosion situation. Even if the operator has control of everything while inside the truck cabin, there is a danger of accidental ignition of the explosive charge.

Published patent document WO2010144952 shows an explosive loading truck, provided with a GPS (Global Positioning System), which enables the truck to automatically fill the holes drilled into a bench. In the truck, information such as the geographic positioning of the holes (latitude and longitude), depth and diameter of each hole, and the level of water found in each hole is stored as measured by personnel before delivery of the explosive. This data is sent to the devices in the truck through a wireless communication path. A major problem with the technology disclosed in WO2010144952 is that the truck requires human operation/intervention at various stages of the operation, for example, while inserting the detonator into the hole and during the data input into the truck. Furthermore, the truck is a standard truck chassis and suspension not specifically designed for dispensing explosives on an incline and/or cross slope. Additionally, an onboard computer uses GPS to position the truck relative to drill holes rather than identifying drill holes to then position the truck. To dispense explosive, the GPS and an encoder on an output of an auger are used to positively position the auger output over a drill.

Published patent document CA 2982284 discloses a method or equipment for deposition of explosives to reproduce activities performed by a manual operator in the deposition of explosives that is free from any human intervention. Particularly, CA2982284 discloses a truck adapted for depositing explosives in holes of open-pit mines automatically and free of human intervention. The truck has GPS and an electronic processor for autonomous travel without any human intervention on the upper surface of a mine bench. The truck is able to direct itself to each of a number of drilled holes. Upon reaching a given hole, the truck is positioned so that the free end of its robotic arm is within reach of the hole to deposit a desired amount of explosive into the hole. However, the truck disclosed in CA2982284 is a standard type truck not specifically designed for negotiating uneven/abrupt terrain, steep gradients and cross slopes at mine sites. Furthermore, the truck first has to locate itself by GPS guidance to a safe distance near to but spaced from the hole of interest, and subsequently has to guide a claw at the free end of the robotic arm to locate the claw over the centre of the hole in order to keep the truck at a safe distance from the hole while delivering the explosives. CA2982284 discusses the need for a vertical translation platform to level the robotic arm relative to the ground and to position the robotic arm at an ideal work height and compensate for uneven ground. This results in requiring a truck positioning system on the truck and a complex claw positioning system on the end of the robotic arm such that the robotic arm has to be controlled relative to the truck and also relative to the ground/hole.

Published patent document CA2818188 discloses a mobile vehicle adapted to operate autonomously to approach a drilled hole from which information is to be obtained. An onboard perception system detects the exact location of the hole, and an onboard sensor is deployed from the vehicle into the hole. The perception system has scanners carried on the rear of the vehicle. A downhole sensor unit movable along a swinging arm carries downhole sensors selectively lowerable into the hole by operation of cable reels within the unit. The disclosed vehicle is a standard off-road vehicle adapted with the perception system and swinging arm mounted on the rear and is not specifically designed or configured for negotiating uneven/abrupt terrain, steep gradients and cross slopes at mine sites while safely carrying a payload such as explosives for deposition into the drilled hole. CA2818188 discloses an arm attached to a mounting on a roof rack on a roof of a standard vehicle. The arm is rotatable about an upright axis to swing a sensor unit in an arc over the ground surrounding the vehicle. The sensor unit is driven along the arm for location over the hole located by a perception system mounted to the rear of the vehicle. CA2818188 assumes the ground under the vehicle is level-contoured, sloping ground or uneven ground under the vehicle is not compensated for by the upright axis for the arc of movement of the arm or for linear movement of the sensor system along the arm. The vehicle and the hole could be on completely different ground contours, making delivery of the sensors difficult or impossible, with the risk of the sensors contacting the inside wall of the hole before reaching a require depth.

Thus, it is concluded that both the manual technique of locating drilled holes based on a pre-planned blasting pattern/map and the semi-automatic techniques shown in the state of the art have one or more limitations with respect to personal safety.

Previous explosives and stemming vehicles are known to be adaptations of common offroad vehicles, still requiring personnel to be present and at a safety risk.

A particular problem exists when trying to identify the location of a drilled hole in the ground, such as for receiving explosive for blasting, without personnel being at risk manually locating the hole(s).

Another problem exists in determining the actual depth of the hole to ensure the correct measured volume of explosive is to be dispensed without needing personnel to be at risk to manually check hole depth.

Explosives and stemming delivery systems are generally powered by internal combustion engine, typically by large mine site vehicles that are diesel powered. The internal combustion engine generates heat sufficient to demand separation between the vehicle and the blast hole into which explosive or stemming is to be delivered. This necessitates articulated delivery mechanisms extending outside the vehicle footprint to distance the delivery point from the heat emanating from the vehicle. This adds complexity to mechanics and, in the case of automation or semi-automation, complexity in identifying the hole and precisely loading the explosive or stemming. A person could stand near to the hole to act as a guide for the vehicle operator to control the articulated delivery mechanism; however, this puts the person at a safety risk.

It would therefore be beneficial to provide capability for a mobile platform or vehicle to identify drilled holes, determine hole depth and/or manage dispensing of a payload (such as delivering explosive and/or a sensing instrument) as an alternative to and/or an advantage over current techniques.

It is to be understood that, if any prior art is referred to herein, such reference does not constitute an admission that the prior art forms a part of the common general knowledge in the art, in Australia or any other country.

### SUMMARY

With the aforementioned in mind, an aspect of the present invention provides an apparatus including a mobile platform for transporting and/or delivering a payload across a ground surface or terrain to a drilled hole or blast hole, the mobile platform including a payload support structure, a plurality of ground engaging means for traversing the ground surface or the terrain, and a suspension arrangement supporting the payload support structure on the plurality of ground engaging means, and wherein the apparatus includes at least one of hole identification system configured to identify location of the drilled/blast hole and/or includes at least one payload delivery arrangement for controlling delivery of payload material from the payload support structure into the drilled/blast hole.

Embodiments may include a remotely controlled vehicle or an autonomous vehicle, or a vehicle controllable to be remotely changed from autonomous operation to tele-operation or vice-versa.

Embodiments may include at least one controllable outlet means configured to control dispensing rate and/or dispensing mass/volume of the payload material into the drilled/blast hole.

The at least one controllable outlet means may include at least one of a variable size opening, a door or doors, clamshell doors, a valve, a hatch, a shutter, openable chute, an auger, a screw feeder/dispenser, a vibratory screw feeder/dispenser, pneumatic, hydraulic or electric actuated valve, a pneumatic, hydraulic or electric actuated door or gate, a slide valve, or a combination of any two or more thereof. Embodiments may include the at least one controllable outlet means including a variable orifice outlet and/or one or more selectable outlets of differing opening dimensions.

Embodiments may include at least one pneumatic, hydraulic or electric actuated said controllable outlet means, such as a pneumatic, hydraulic or electric actuated slide valve or doors/clamshell doors. The at least one slide valve or clamshell type doors may include selectable outlets of differing opening dimensions.

The at least one hole identification system may include at least one image capture device, such as a stereoscopic, LIDAR, artificial intelligence (AI), computer vision or 3D camera arrangement. Al and/or computer vision can be employed to interpret and understand from digital images (e.g. from cameras and videos and deep learning models) accurate identification of features, such as position and/or shape of a hole opening.

LIDAR (light detection and ranging) or other EM/laser ranging technology can be used to identify distance to an object (such as a hole opening) and/or create digital 3D representations (e.g. 3D laser scanning, a combination of 3D scanning and laser scanning) of the topography to identify holes or features of holes therein.

Embodiments may include the at least one hole identification system having at least one processor arranged and configured to calculate distance from a reference to one or more points on the drilled/blast hole. The at least one processor may be configured to determine distance from the reference to a point on an edge of an opening of the drilled/blast hole to the reference.

Embodiments include the at least one hole identification system being configured to identify two points within acquired data (such as perception or image data) where the difference in distance from the at least one image capture device to each of two points of interest are a maximum for the acquired data. A first point in the data may represent a nearest point or candidate point of a potential hole to be identified.

perception system arranged and configured to obtain data relating to location, shape, state or angle of the hole, or a combination of any two or more thereof.

The perception system may include at least one image capture device and/or at least one distance and ranging system, the respective system providing respective contrast or distance data.

The at least one hole identification system may include a stereoscopic camera arrangement, a lidar system, a radar system or a colour or grey scale contrast analyser, or a combination of any two or more thereof.

Beyond the first point, if distance changes suddenly to a second point, representing a far side internal hole wall within the drilled/blast hole, difference in distance between the first point and the second point may be identified as the largest difference within the region of interest in the image data, and the first point is determined to be the most suitable candidate point being at the edge of the drilled/blast hole. Data points beyond the best candidate point may represent the difference in distance reducing.

Embodiments include the payload support structure having a container or hopper for holding explosive or stemming as the payload material.

Embodiments may include a hole depth measurement arrangement. The hole depth measurement arrangement may include at least one winch, which may have a flexible elongate member supporting a probe (such as a weight/mass) for lowering into the drilled/blast hole.

Embodiments of the hole depth measurement arrangement may include at least one load sensor to sense change in tension in the flexible elongate member. The at least one load sensor may include at least one torque sensor, such as a using torque arm load sensing/sensor.

At least one encoder and/or at least one rotation sensing device may be provided to be used to determine or measure how much (e.g. length) of the flexible elongate member (such as a cable) has been belayed down the hole. The at least one encoder and/or the at least one rotation sensing device may include at least one rotary encoder and/or at least one optical device.

An optical device may include illuminating markers or illuminating through holes in the elongate flexible member (such as markers on a tape or spaced holes through the tape).

Change in tension may be taken as an indicator that the probe (e.g. the weight/mass) has been reached by the explosive during filling the hole, has reached hole bottom, has reached an obstruction, or has reached water level in the hole, or a combination of any two or more thereof.

Variation or pulses detected in the changes in tension can indicate that the weight/mass has become submersed in the payload material dispensed into the drilled/blast hole.

For example, with respect to dispensing explosive into the identified hole, the mass/weight can be positioned at a desired height/depth in the hole such that it hangs statically within the flow of dispensing material. The tension on the elongate flexible member (e.g. cable) as a result of material flowing over the mass/weight remains relatively constant. When mass/weight becomes immersed in the flow, the tension drops off and can be detected.

Embodiments of the apparatus may include a position controllable outlet to direct the dispensed payload material into the opening of the drilled/blast hole. The position controllable outlet may include a flexible guide, channel, chute or funnel below the outlet valve.

A dispensing position of the position controllable outlet may be controlled by one or more positioning actuators. The one or more positioning actuators may include one or more rotary actuator, one or more linear actuator, one or more pneumatic, electric or hydraulic actuators, one or more winches, one or more motors, one or more cylinders or rams, or a combination of any two or more thereof.

Embodiments include the one or more positioning actuators is/are controlled to position the position controllable outlet automatically/autonomously via processor control, or to position the position controllable outlet via operator controlled tele-remote interface.

Embodiments of the mobile platform or vehicle may be arranged and configured to straddle the hole for dispensing the payload material. Embodiments of the mobile platform or vehicle may be configured to dispense the payload material whilst positioned over the hole.

Embodiments include a vehicle or other mobile platform, preferably an electric powered vehicle or mobile platform, which reduces heat generation relative to an internal combustion engine powered vehicle.

The electric vehicle/mobile platform can straddle the drilled hole/blast hole for safe delivery of explosive and/or stemming, or indeed, a probe or other payload for delivery downhole.

Straddling the hole can include ground engaging means (such as wheels or tracks or a combination thereof) of the vehicle or platform being spaced around an opening into the hole/either side of the hole, to support a working platform and/or payload/payload delivery arrangement over the hole.

Embodiments of the vehicle/mobile platform can be autonomous (self-controlling) or semi-autonomous (capable to some extent of operating without human control).

Embodiments include at least one sensor for use in identifying the hole and preferably for use in positioning the vehicle/mobile platform relative to the hole, more preferably straddling the hole. The at least one sensor may include one or more cameras and/or electromagnetic ranging device (such as infra-red, radar or lidar).

Embodiments include a payload delivery arrangement, which may include one or more of at least one valve, at least one outlet (such as one or more nozzles), a retraction system to retract the at least one outlet (e.g. upward retraction) to prevent the at least one outlet disturbing drill cuttings as the vehicle/mobile positions over or passes over the hole.

Embodiments advantageously provide more efficient and/or faster cycle time compared to articulated external ‘arm’ mechanisms because payload delivery within the vehicle/mobile platform footprint (such as when straddling the hole) does not need to take time to extend and retract such an arm and conduct positioning at a distant reach.

Embodiments can provide for more effective and efficient hole identification, location and/or precision loading of payload into the respective hole.

Embodiments include dispensing within the footprint of the vehicle/mobile platform, enabling use of simpler systems/components with fewer moving parts relative to an articulated arm arrangement, thereby resulting in corresponding reduced manufacturing costs and maintenance.

Importantly, embodiments of the present invention can enable reduced requirement for personnel to be in the vicinity of the blast hole during dispensing of explosive or stemming.

Hole identification/location. Embodiments include at least one hole identification system, which may include at least one perception system arranged and configured to obtain data relating to location, shape, state or angle of the hole, or a combination of any two or more thereof.

Embodiments may include the at least one perception system including at least one image capture device and/or at least one distance and ranging system, the respective system providing respective image, contrast or distance data, or a combination of any two or more thereof.

Embodiments of the at least one hole identification system may include a stereoscopic camera arrangement, a lidar system, a radar system or a colour or grey scale contrast analyser, or a combination of any two or more thereof. at least one distance measurement device (such as LIDAR/3D laser scanner, ultrasonic device, radar, infra-red or other electromagnetic signal device) and/or at least one image capture device, such as at least one camera.

Embodiments of the at least one hole identification system may include multiple image capture devices. For example, embodiments may include a stereo camera arrangement.

Embodiments may include a stereo camera arrangement, such as with two lenses, preferably with a separate image sensor for each camera/lens or a single sensor for capturing images side by side from each lens, to simulate human binocular vision to capture three-dimensional images.

The at least one hole identification system may include a processor arranged and configured to calculate distance from a reference (such as from a stereo camera arrangement) to one or more points on the hole.

Preferably, height from the ground at or adjacent the hole is determined or known. For example, height (H) of an image capture device, such as a camera/stereo camera arrangement, can be used with geometry to determine/calculate horizontal distance (L) from image capture device/camera to the specific point. For example, the specific point may be the near edge of the hole to the image capture device(s).

Embodiments may employ part of the full captured image as the search area for identifying the hole. For example, a central portion of the captured image of the hole may be used as the search area.

The size of the search area, as influenced by the height and angle of the at least one image capture device (such as a camera) relative to the hole, may be predetermined. For example, preferably the at least one image capture device may be provided about 1 meter from the ground surface with an image capture area of 1.2 m×1.2 m, which may be divided into sub regions of the respective image to identify presence of a hole in each sub region.

Variance for each of the sub regions of interest is preferably determined to assess whether any particular sub region contains an image of the hole. If there are no holes identified in a sub region, then the variance of that sub region can be given a value. If there are one or more holes identified in the particular sub region, the respective variance can be given a value above or below a threshold value. For example, if there are no holes identified in a sub region, then the variance of that sub region can be given a value, but if there are one or more holes identified in the particular sub region, the respective variance can be given a relatively higher or lower value. Embodiments may include assigning a sub-region of no holes a lower value, say 200-500, and a sub-region with at least one hole a value, say, 1000 or more.

Embodiments may include limiting/putting a range on, the minimum or maximum distance from/to the hole, may compare against an expected hole size (e.g. diameter), or may compare with other images from other cameras, or may compare to a reference hole image.

Embodiments may include employing multiple sensors (such as multiple cameras or other light sensors) in conjunction in ‘sensor fusion’ whereby data from multiple such sensors can be combined (e.g. merged). Sensor fusion can be employed to reduce any uncertainty in positioning, navigation or performing the required task.

Embodiments may allow for the ground surface being at an angle relative to the at least one image capture device. For example, the ground surface into which the hole extends may be horizontal or may be on a slope, sloping upwards and away from the at least one image capture device, or sloping downwards and away from the image capture device.

Other angles are considered to fall within the scope of the capability of embodiments of the present invention. By way of example, for a horizontal image capture device viewing directly downwards, different topographies will be observed depending on the levelness or slope of the ground surface around the hole. However, if the image capture device is angled for non-vertical imaging, a similar image may result regardless of levelness or slope of the ground surface.

Embodiments include identifying in captured image data a point at an edge of the hole to be identified. Embodiments may include finding two points within the image data where the difference in distance from the image capture device to each of two points of interest are a maximum for the image data. For example, a first point in image data may represent a nearest point of a potential hole to be identified (candidate point). Beyond (above, for example, in the image) that point, distance changes suddenly to a second point, representing the far side internal hole wall within the hole.

Embodiments of the hole identification system can include arrangements to identify or determine differences between values in sensed/image data. For example, distance to the first point (D1 say) and the second point (D2 say) may be assessed. If the first point is the most ideal point of the image data, the difference in distance between D1 and D2 from the image capture device may preferably be the biggest within the region of interest. Alternatively, or in addition, embodiments may include assessing drop off/variance in contrast in sensed light/image values to identify a region or point of relative high contrast or region/point of interest.

Embodiments include using image data to represent a region of 3D space (such as the 3D space encompassing a drill/blast hole opening). For example, a colour coded ‘map’ of distance data or a 3D point cloud visualization of image data points or geo-referenced points (such as from lidar/laser scanning).

Embodiments can include colour or greyscale in image data to represent distance. For example, different colours or shades of grey may be used to represent the distance from image capture device to the respective point of interest. The ‘best’ point of interest that is most likely to represent an edge of a hole is where the distance data (changes the most within the data set) has the largest large distance change.

After identifying the most suitable candidate point as the edge of a hole, a search in the image data of the points beyond the best candidate point can be conducted, checking for the difference in distance reducing, and in ideal situation, the point is totally same as other points thereby identifying the opposite edge of the hole. Thereby confirming that a hole is present in the image data.

Hole depth. Before putting explosive or other product into a blast hole, the hole can be ‘dipped’ to ascertain hole depth. Such ‘dipping’ involves lowering a tethered weight down a hole until it reaches the bottom. The hole depth is then measured against markings on the tether. The results are recorded, usually on a paper load sheet, and at the completion of the task the results are submitted to the shotfirer or blasting engineer. Often the results are not received early enough to adjust blast design or the paperwork is illegible. Human error is not uncommon, making verification problematic.

Embodiments of the present invention address one or more problems associated with verifying hole depth. Embodiments may include providing a hole depth measurement arrangement.

For example, a hole depth measurement arrangement may include a winch having a weighted flexible elongate member that is lowered until a distal end reaches a bottom of the blast hole (e.g. up to 40 m deep). The winch and/or the flexible elongate member can be calibrated to provide a measure of depth, such as a rotary encoder depth gauge on the winch and/or a calibrated distance measure on the flexible elongate member. Preferably the depth measurement is electronically captured and recorded.

The depth information can be provided to the blast software and/or blast engineer, preferably in real time. The hole can be backfilled if overly deep or drilled out further if the hole is insufficiently deep, and the blast plan can be updated with the new depth data. Advantageously, more accurate quality control of blast hole depth is created, resulting in improved blasting outcomes. The winch can be mounted on the vehicle/mobile platform, and electronically controlled (such as autonomously or remotely controlled by an operator).

Embodiments may include the hole depth measurement arrangement including a probe (such as a weight of known volume/mass) that is lowered on a flexible elongate member to the expected depth using a powered winch, preferably of known reel diameter. Tension change in the flexible elongate member can be detected as an indicator that the weight has reached hole bottom, reached an obstruction, or has reached water level in the hole.

The hole depth measurement arrangement can also be used to determine that a filled hole is at the expected fill level by detecting the top of the filled material. Pulses are detected through the weight cable and can recognize when the weight has become submersed in the fill material.

Dispensing payload (explosive, stemming). Embodiments of the vehicle/mobile platform may include an outlet valve for releasing and dispensing payload from the container (such as a hopper) of the vehicle/mobile platform. The outlet valve may be controlled to open and close, such as by an electric, pneumatic or hydraulic outlet valve actuator. The outlet valve may include a slide type valve and/or one or more pivoting door(s)/clamshell type doors. Preferably the outlet valve includes multiple dispensing position, such as fully open, partially open or reduced/restricted opening (reduced relative to fully open) and closed.

For example, an outlet valve may include a large opening for maximum dispensing rate (such as when a high volume of payload is to be dispensed or when a payload of lower flow rate is to be dispensed e.g. stemming), a smaller/restricted opening (relative to fully open—e.g. 100 mm diameter) to reduce rate and/or volume of payload being dispensed (such as when a blast hole is nearly full and a smaller controlled rate of dispensing is needed or when a payload of higher flow rate is dispensing e.g. ANFO).

A dispensing outlet to the blast hole may receive payload from the container/hopper and have a position controllable outlet to direct the dispensed payload into the opening of the blast hole.

Embodiments include a chute below the outlet valve, such as below the clamshell doors which can be controllably opened for dispensing the payload into the chute. The chute may be directed, such as by motors, rack and pinion, and/or positioning winches (such as X, Y axis horizontal position control) to position the outlet of the chute above the opening/collar of the hole to receive the dispensed payload from the container of the vehicle/mobile platform. The chute may include a flexible chute, a rigid chute or a semi-rigid chute.

Gross and Fine Positioning. Gross positioning can relate to positioning the delivery system close enough to the hole for the delivery mechanism to reach. The current practice on the flat is for a human to drive the vehicle to this location and visually identify the hole. On contour blasts the vehicle cannot achieve this gross positioning requirement (explosives and stemming are manually bucketed to the blast pattern). Both methods require significant human involvement and therefore high cost.

Fine positioning can relate to positioning the vehicle/delivery mechanism where explosives or stemming can be delivered into the hole without unreasonable spillage. Current problem is that this requires humans to manoeuvre the mechanisms or material to the blast hole.

Embodiments of the present invention may include automated navigation of the vehicle/mobile platform, such as through use of a global navigation satellite system (GNSS), such as GPS positioning, blast pattern design software, sensors (e.g. LIDAR, image capture means/cameras) and/or automation control (such as functional control software run by a processor and control system of the vehicle/mobile platform).

Accurate Dispensing. Blasts at mine sites are designed with a specified mass of explosives per hole and a specified height that mass of explosive should reach for each blast hole of a given bore diameter and any stemming in the blast hole.

The blast pattern can be unpredictable if only one variable is measured and the other deduced, and both the mass and the explosive level/height need to be measured to conform with the blast design/pattern and desired blast effect.

The reason mass and height often disconnect from the theoretical is because the blast hole isn't always as expected. The void can be less than expected (e.g. a worn drill bit, water ingress, rock falling back into the hole, poor drilling practices) leading to the specified mass of explosive reaching higher in the blast hole than intended. At best this leads to poor blast outcome and at worst dangerous fly rock.

Alternatively, the void could be greater than expected (usually due to a fissure or natural void syphoning or wicking explosives into unexpected locations or poor drilling practices). This can lead to poor blast outcomes, dangerous blasts where the energy is released in unexpected areas, or excessive explosive being loaded to reach the desired height resulting in fly rock.

In contour blasting where measurement of mass is manual (i.e. number of buckets of explosive emptied into the blast hole) quality control and assurance is particularly difficult.

Measuring explosive height is either not done or done manually, usually involving a long pole, with measurement markings, held in the hole by an operator who asks the loader to stop when the pole “floats” to a pre-determined mark. The poles are long enough to measure the top of the explosive column but seldom long enough to reach the bottom of the hole, so when a crack or void prevents the hole from filling (because the explosive is leaking elsewhere) the operator is unaware until significant amounts of explosive have already been dispensed into the hole. This means there is a significant amount of explosive where it should not be before loading is stopped. Moreover, in the case of a hole collapse, the detonator may not be submerged in the explosive, which could lead to a misfire.

As discussed above, a hole depth measurement arrangement can be provided. For example, a weight on flexible elongate member of a calibrated winch can be lowered into the blast hole and the hole depth determined by detecting the bottom of the hole (e.g. up to 40 m). This information can be relayed back to the blast software and backfill arranged or blast design updated if the hole is deeper or shallower than desired.

The weight may be raised 1-2 m off the bottom of the hole (e.g. where the detonator/booster is positioned).

Loading the explosive into the hole is commenced. The ‘dipping’ hole depth measurement arrangement can be configured to detect a change in tension of the flexible elongate member (such as a cable, line, string, tape, which may be marked with calibrated measurements or the winch may include a rotary encoder type measurement device). Change in the tension can be measured, such as with a load cell attached to a pulley and/or with a tension arm which is connected to a servo motor with a configurable torque limit.

Embodiments of the vehicle/mobile platform may include a processor to compare quantity of dispensed mass to the quantity of mass expected to be dispensed 1-2 m from bottom of hole. If the rate of fill of the first metre of the hole is too quick or too slow compared to expected, it indicates there may be a cavity where material is seeping or a collapse that could result in the explosive not reaching the detonator and resulting in a misfire.

Once the weight at the end of the flexible elongate member is detected as being immersed (e.g. detection through change in tension), the dispensing outlet valve may then be closed. Alternatively, or in addition, the flow of payload material dispensing may continue whilst retracting the probe (e.g. the mass/weight), such as to the final load height.

The weight can then be raised to the designed explosive column height and the process above repeated to confirm explosive height has been reached, and loading stopped.

If the hole depth measurement arrangement (e.g. dipping winch arrangement) has not detected immersion of the weight once a target load-out mass of explosive has been detected, the outlet valve can be closed and the operator alerted to a variance error.

Embodiments may include timing dispensing of payload material. For example, the mobile platform/vehicle may have a timer or may be provided with a timing signal from a remote location.

If an expected dispensing time period elapses but the expected mass/weight/volume of payload material to be dispensed or a mass/weight/volume thereof has not been reached, or if the probe is not immersed in the dispensed payload material, embodiments may include providing or initiating a fault/error condition e.g. the output has become clogged.

It will be appreciated that the weight may be raised at several/smaller intervals and measurement taken more frequently to ensure there are no anomalies throughout the hole.

Embodiments include determining height of stemming, such as via at least one image capture device (e.g. stereoscopic/3D camera rather than manually).

Beneficially, embodiments of the present invention provide increased efficiency over manual processes, more timely and accurate measurement and recording of the blast hole depth. Also, more timely identification of cavities and cracks result in reduced loss of containment and lower hazards for personnel and blasting operations. Furthermore, real time or near-real time verification of “as loaded” data helps to improve safety and assurance of correct blasting technique compliance.

Blast hole depths, blast hole diameters and blast hole spacing/pattern are predetermined for the blast plan. Hole diameter can be verified approximately by the image capture system on the vehicle/mobile platform (such as a vision system—e.g. stereoscopic/3D camera system).

Hole depth can be assessed by dipping, such as with a sensor or sensor enabled winch. As payload (such as explosive) is dispensed, a dipping sensor may be at the correct fill height in the hole and will detect when correct height is achieved. For example, load on a payload weight at the end of a flexible elongate member can be monitored (e.g. to the nearest 20 kg).

Dispensing of the payload can be shutoff at a threshold, which may, in some embodiments, be determined by a measure of reduction of tension on the flexible elongate member or load applied by the weight.

If the amount of payload material dispensed exceeds the amount required/expected, the height of the infill is checked by dipping, and reported. If outside of predetermined threshold, the hole may be flagged as being out of specification or having one or more cavities.

Embodiments include measuring height of material in the hole during dispensing (e.g. mid-flow) based on the force exerted by the flow of dispensed payload material against a mass/weight that is suspended within the flow. This force applies a semi-consistent tension in the flexible elongate member (such as a cable, tape or string) which tension may be measured by a load cell, preferably at the winch. Once the mass/weight is immersed in the material the tension rapidly drops off and it can be determined that the material has filled the hole to this height.

One or more particular embodiments of the present invention in use will hereinafter be described. Vehicle is stopped. Remote operator initiates payload delivery sequence to unload a volume of payload material (such as explosive) into a predrilled blast hole. Amount of payload and loading requirements are provided from a predetermined mission plan. The hole is identified/located, such as by using an embodiment of the aforementioned hole identification arrangement/system (e.g. using image capture means/stereoscopic camera system).

A fine positioning system onboard the vehicle/mobile platform can move the dispensing outlet (such as a tube/chute) into position above the opening/collar of the identified hole. Preferably, the operator uses remote (tele) monitoring to obtain confirmation to load the payload into the hole. The dipping probe (e.g. weight/mass) is deployed suspended from the flexible elongate member using the winch to the cavity detection height within the blast hole. The outlet valve is remotely controlled to open and dispense the payload.

A detonator immersion check can be conducted by comparing quantity of dispensed payload to the expected quantity 1 m from bottom of hole-if first metre has filled quicker or slower than expected for the depth and diameter of hole, this indicates there may be a cavity where payload material is seeping or a collapse that could result in the payload material not reaching the detonator and potentially resulting in a misfire.

The probe may include or be a weighted end of the flexible elongate member. The probe (e.g. weight/mass) on the flexible elongate member suspended by the winch is raised to stemming height within the hole as flow of the payload continues (assuming an error was not detected prior).

If immersion detected: the dipping winch detects a change in tension of the line—e.g. measured with a load cell attached to a pulley and/or with a tension arm which is connected to a servo motor with a configurable torque limit.

The outlet valve is then closed once the mass/weight at the end of the winch elongate flexible member is detected as being immersed in the payload material delivered into the hole.

Alternatively, if the dipping winch has not detected immersion of the mass/weight once the target loadout payload material volume/mass has been detected, the outlet valve is closed and the operator alerted to a variance error.

Dipping winch ‘touched off’: If there was not a time out-the dipping winch retracts the mass/weight until it is no longer immersed in the delivered payload material. The dipping winch can then be used to touch the mass/weight on the top of the material in the filled hole to record the final stemming height. Dipping winch weight/mass is then retracted to its retracted position. The fine positioning system can then retract the delivery chute/tube outlet to a ‘home’ retracted position. Payload mass/volume delivered to the hole, fill time taken and depth are preferably logged to a database/record.

The mobile platform/vehicle may include at least one sensor system and at least one sensor for sensing at least one of: features of the ground surface/terrain, geo-fenced boundary, blast/drilled hole location. The at least one sensor system may include one or more of lidar, radar, infra-red, camera, inclination/incline sensor, GPS.

The payload support structure may include a container or hopper for holding explosive or stemming. The mobile platform may include at least one outlet with an opening, controllably openable and/or closeable, to underneath the container or hopper for dispensing the explosive or stemming into the drilled/blast hole while the mobile platform straddles the drilled/blast hole.

The apparatus may include at least one load sensor for sensing a payload supported by the payload support structure. The at least one load sensor may include at least one load cell arranged and configured to sense a payload weight or mass present within the payload container or hopper.

A further aspect of the present invention provides a method of delivering a payload material to a hole, such as explosive and/or stemming to a blast hole, the method including positioning a mobile platform or vehicle over a hole of interest, positioning a payload material delivery outlet relative to an opening of the hole for dispensing the payload material into the hole.

The mobile platform or vehicle can be remotely or autonomously controlled to straddle the opening of the hole, such as having the support platform above the hole with the ground engaging means at locations around the hole.

The delivery outlet may be controlled autonomously or remotely to position the delivery outlet such that payload material dispensed from the mobile platform/vehicle is delivered into the hole.

The hole of interest may be identified autonomously by the mobile platform or vehicle, such as by use of an onboard hole perception/identification system, or remotely by an operator employing the onboard perception/identification system.

A further aspect of the present invention provides a method of identifying a hole, such as a blast hole or drilled hole, the method including deploying a mobile platform or vehicle having an onboard perception or identification system, using the perception or identification system to identify a hole of interest, moving the mobile platform or vehicle to be adjacent or over the hole of interest.

Embodiments my use one or more cameras and/or one or more distance measurement devices, such as radar, lidar, infrared or laser ranging devices, to determine distance to a hole, physical features to identify a hole (such as features of a hole opening).

### BRIEF DESCRIPTION OF THE FIGURES

One or more embodiments or examples of the present invention will hereinafter be described with reference to the accompanying Figures, in which:

FIGS. 1A and 1B show free space views of a mobile platform or vehicle with load conveying and dispensing capability according to an embodiment of the present invention.

FIG. 1C shows a cross-section A-A of the mobile platform/vehicle in FIG. 1B according to an embodiment of the present invention.

FIGS. 2A to 2D show examples of hole identification arrangements for a vehicle or mobile platform according to an embodiment of the present invention.

FIGS. 3A to 3C show outlet valve positions according to an embodiment of the present invention.

FIG. 3D1, 3D2, 3E1, 3E2 and 3F show features of an alternative outlet valve in the form of controllable pivoting doors, such as clamshell type doors that close together to shut the opening and can be pivoted apart to open the opening to dispense the payload, according to an embodiment of the present invention. FIG. 3D1 and 3D2 show respective side and bottom views with the outlet closed. FIG. 3E1 and 3E2 show respective side and bottom views with the outlet open. FIG. 3E shows an end on view showing the actuator connecting to outlet door arrangement.

FIGS. 4A and 4B show dipping winch weight/mass and load detection for use in determining progress or status of hole fill, according to an embodiment of the present invention.

FIG. 5 shows a chart of force (N) vs Time(s) representing outlet valve open-closed position (broken line) and load (force) on a dipping winch weight/mass/probe (solid line) in determining load dispensed from a mobile platform/vehicle according to a further embodiment of the present invention.

FIGS. 6A and 6B show views of a mobile platform/vehicle with articulated suspension, variable steering and load dispensing capabilities, according to an embodiment of the present invention.

FIG. 7 shows a view of an arrangement for dispensing material and fine positioning of an outlet for delivering the material to a hole according to an embodiment of the present invention.

FIG. 8 shows an underside plan view of a mobile platform or vehicle with payload material delivery outlet fine positioning arrangement according to an embodiment of the present invention.

### DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented.

It will be readily understood that the aspects of the present disclosure, as generally described herein and illustrated in the drawings can be arranged, substituted, combined, separated and designed in a wide variety of different configurations, all of which are contemplated in this disclosure.

Embodiments of an apparatus of the present invention include a mobile platform or vehicle 10 arranged and configured to transport a payload over terrain, e.g. contoured terrain, steep gradients and cross-slopes 11, such found at mining areas/mine sites. The payload can be explosives, such as ANFO (prilled ammonium nitrate (AN)+fuel oil (FO)) carried in a container, such as a hopper 14 or other reservoir, such as a tank. Alternative or additional payload can include instrumentation, such as for measuring downhole characteristics of a borehole/drilled hole e.g. one or more drilled holes for receiving explosive for a planned blasting operation.

It will be appreciated that the payload support structure 12 can provide a platform or chassis 12 of the mobile platform/vehicle 10, which can be adapted/configured to transport a choice of various payloads as required for a particular operation.

Embodiments of the mobile platform or vehicle 10 can be fully autonomous, semi-autonomous or tele-remote operation.

Embodiments may include at least one load sensor 15 for sensing a payload supported by the payload support structure 12. The at least one load sensor 15 may include at least one load cell 17 arranged and configured to sense a payload weight or mass present, such as within the payload container or hopper 14.

Embodiments of the mobile platform or vehicle 10 can include independent suspension for each ground engaging means and/or independent steering for each ground engaging means. Preferably, a leading pair of ground engaging means and/or a trailing pair of ground engaging means (leading and trailing relative to a forward direction of motion) such as at the respective leading and trialing ends of the mobile platform or vehicle can turn/steer together in a similar direction (e.g. to go left or right). Any ground engaging means between the leading and trailing ground engaging means may have pairs that have ground engaging means which are controlled to turn an amount less than the leading or trailing ground engaging means, or not turn at all, for steering control and positioning control.

Embodiments can include a suspension arrangement 18 (e.g. 18a, 18b, 18c, 18d) configured to support the payload support structure 12 and thus the payload (such as explosive in the hopper 14) on ground engaging means 16 (e.g. 16a, 16b, 16c, 16d). It will be appreciated that the mobile platform or vehicle 10 can have an even number of ground engaging means, such as 4, 6, 8, 10, 12 or more wheels/tyres. Wheels/tyres 16a, 16b, 16c, 16d can include treaded or smooth tyres.

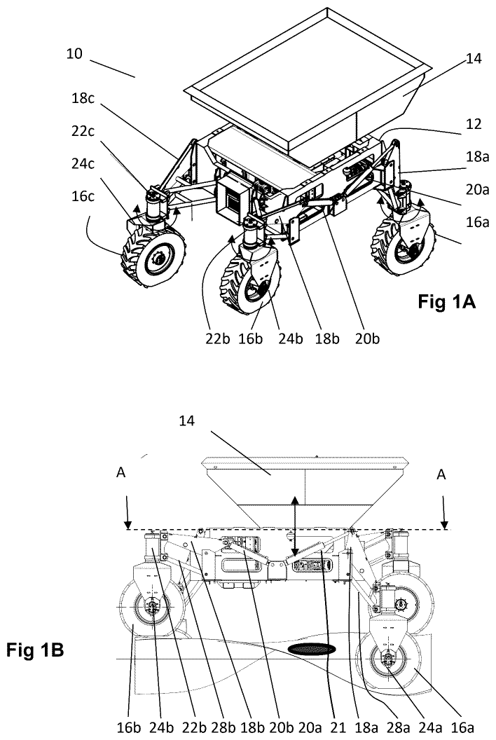

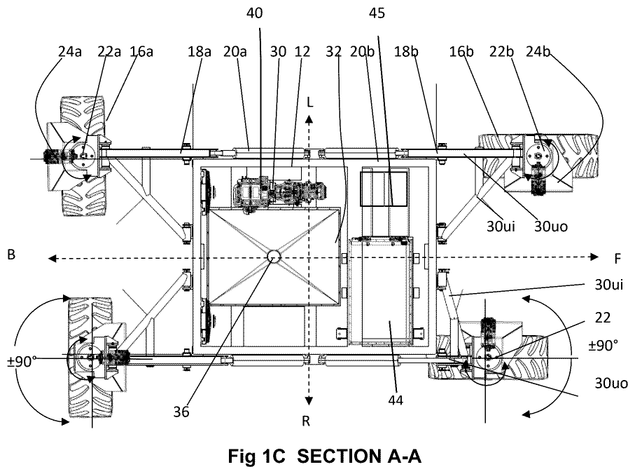

For steering and direction control, some or all of the ground engaging means can be rotated about a respective upright axis associated with the respective ground engaging means-see for example FIGS. 1A to 1C. Steering and direction control can be provided by hydraulic or electric drive to power rotation of the respective ground engaging means about the respective upright axis.

In embodiments, the ground engaging means at the same end of the mobile platform/vehicle (e.g. wheels 16a, 16d and/or 16b, 16c) can be turned in concert to provide steering/direction control. However, it will be appreciated that embodiments include independent control of the ground engaging means for maximum steering and direction control ability. For example, diagonal ‘crabbing’ motion can be imparted for fine positioning or to avoid rocky/uneven ground surface/terrain.

For suspension and load levelling (such as on gradients and cross-slopes), the suspension arrangement 18 enables movement of the respective ground engaging means relative to the payload support structure (and therefore the payload) and vice versa. For example, on uneven ground 11, the suspension 18a, 18b, 18c, 18d for one or more of the respective ground engaging means can be actively operated/controlled to raise or lower the respective ground engaging means (or reciprocally raise or lower the associated part of the payload support structure/chassis 12 and therefore a portion of the payload to adapt to the uneven ground or to maintain the payload level, or both.

The suspension 18 can be actively driven, such as by at least one actuator 20 (e.g. single acting or double acting rams 20a, 20b, 20c, 20d). A single acting actuator can be driven to extend, with return contraction action provided by gravity/weight acting through the suspension arrangement.

Alternatively, a double-acting actuator can be driven to extend and driven to retract, providing quicker action and better overall control compared to the single acting arrangement. The respective actuator(s) can be hydraulic or pneumatic rams or electric actuators.

Embodiments include an onboard power supply, such as batteries and/or hydraulic drive system, which can be provided on the support structure/chassis 12.

The adaptability of the suspension arrangement and the steering/direction control of the ground engaging means provides for gross and fine movement control of the mobile platform/vehicle 10 across the ground surface/terrain 11.

Embodiments of the mobile platform/vehicle 10 can include one or more sensors to identify obstacles/hazards.

### Embodiments Include:

1. the mobile platform/vehicle (which is responsible for gross and fine movement) across the ground surface/terrain and houses sensors to identify obstacles/hazards, locate the blast hole;
2. software controlling autonomous and/or tele-remote operations; and
3. the payload, such as the container and explosive/stemming and/or instrumentation/sensory equipment having one or more sensors and/or data capture devices.

It will be appreciated that the mobile platform/vehicle need not support a container/hopper for explosive/stemming. The mobile platform/vehicle can support instrumentation/sensory devices for investigating and/or logging ground surface/terrain or a blast hole map/pattern for future blasting or geo-surveying/downhole surveying or material for hole lining.

The payload may be carried in a container, hopper or other suitable reservoir 14, or as an instrument package. A container or hopper 14 containing the explosive or stemming may be dispensed into a drilled/blast hole when informed to do so by a controller onboard the mobile platform/vehicle.

By way of example, in use, bulk explosive product (e.g. ANFO) can be loaded into the container (e.g. a hopper or other reservoir 14) from an explosive mobile mixing unit (MMU) or mobile processing unit (MPU) provided near to the area to be blasted or from a bulk explosives depot on or near the mine site.

Alternatively, the container can be loaded with stemming material, such as by a truck and mechanical shovel, larger hopper, skid steer loader, forklift etc. Stemming material is used top-off the blast hole to contain the blast of the explosive to maximise fragmentation of the rock. The explosive or stemming can be several tonnes, such as 4-8 tonnes, preferably around 6 tonnes, but can be less or more for a particular application and capacity of the container/hopper.

The mobile platform or vehicle receives instructions from a control system e.g. blast pattern data, GNSS data, GPS data. Preferably the mobile platform/vehicle self-transits to the blast pattern site autonomously. However, tele-33 remote control or line-of-sight may be provided as an alternative or back-up control/guidance arrangement.

In the case negotiating significant gradients for contour loading, the mobile platform/vehicle suspension accommodates uneven ground and the steering/direction control can avoid obstructions and provide gross/coarse and fine positioning at or over a blast hole, such as by straddling over the blast hole.

Embodiments include the suspension arrangement providing ground engaging means (e.g. wheel 16) up-down articulation range between 1.0 m and 1.5 m, preferably 1.1 m to 1.3 m, and more preferably around 1.2 m, between maximum height up and minimum height down.

Embodiments include the steering and direction control, such as providing +/−135° steering/direction angle for each ground engaging means (preferably +/−90°, more preferably +45° to −135° (135° in the one direction catering for the reduced 45° in the other direction to allow for effectively +/−90° steering) per ground engaging means), such that at full +/−90° the mobile platform/vehicle can transit fully sideways left or right (L, R) at 90° relative to a forward-backward (F-B) direction of travel.

Steering drive can be provided by a steering power means 19, such as for powering steering for each ground engaging means 16 Drilling rigs and the like are commonly propelled on tracks to spread weight. However, such vehicles cannot readily change direction to fine tune positioning when near a hole to be loaded with explosive or to deploy an instrument package down the hole. Tyres/tires are preferred to reduce damage to the ground surface and any contact with initiation systems such as shock tube or blast cord on the ground. Change in direction of the ground engaging means without churning the ground as much as a track/skid-steer system is less likely to break or damage blast hole collar or initiation systems such as explosive fuse/blast cord trailing on the ground.

Embodiments of the present invention can include actuator (such as ram/cylinder) pressure regeneration if sufficient pressure is not sensed for a particular ground engaging means.

Embodiments include each ground engaging means is powered, such as by a drive means, such as a hydraulic motor, pneumatic motor or electric motor, preferably connected to an output gearbox to provide a required final drive ratio to the respective ground engaging means.

Embodiments including a hydraulic system can include on-board electric power, such as one or more batteries and an electrically driven hydraulic pump arrangement to power the hydraulic system. Embodiments can include a hydraulic distribution arrangement 45, such as to distribute hydraulic power to various components. A hydraulic pump arrangement 47 can be provided. Embodiments can include at least one electric motor 49, such as for powering one or more hydraulic pumps, the fine positioning arrangement and/or the dipping winch.

Alternatively, or in addition, a plug-in electrical supply can provide the electrical power.

Alternatively, embodiments can include electric drive using electric motors to power the ground engaging means, such as an electric motor, optionally having an output gearbox to modify final drive, for one or more of the ground engaging means (such as electric motor driven wheels).

Likewise, embodiments can include electrically actuated suspension and/or electrically sensed load, travel or pressure on the respective suspension components for use in detecting and/or overcoming obstacles or for decision making in changing direction to avoid tackling the obstacle.

It will be appreciated that load levelling can be provided by suspension articulation. Furthermore, to facilitate detection of obstacles and gradients, embodiments of the mobile platform can include at least one accelerometer and/or gyroscope. By detecting or measuring pressure at or to/from one or more of the suspension actuators (double or single acting), regeneration can be used to help stabilize the mobile platform/vehicle should it drive over a drilled/blast hole. In such instances, the suspension can be operated to level the load and/or extend a ground engaging means to engage with the ground surfaced within the hole within the limits of the travel of the suspension system.

It will be appreciated that having six (6) or more spaced ground engaging means can provide greater stability should one ground engaging means be suspended over a hole. Embodiments having ground engaging means at four positions (front left, front right, rear left, rear right) may be provided with greater suspension travel than embodiments with 6 or more ground engaging means.

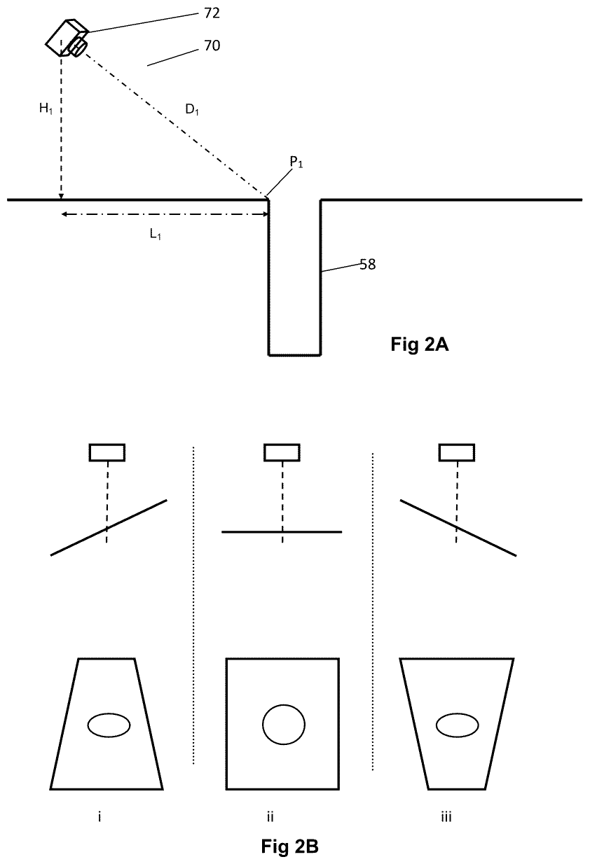

Embodiments of the suspension arrangement 18 can include upper and lower suspension links associated with the suspension for at least one of the ground engaging means, preferably for each of the provided ground engaging means. For example, the ground engaging means 16 or each ground engaging means 16 (e.g. 16a, 16b, 16c, 16d) can have up and down suspension arrangement 18 travel (see up-down arrows shown in FIGS. 1B, 1C, 2B and 2C) by connection to the support platform via a respective upper suspension link arrangement 26 and a respective lower suspension link arrangement 28.

An upper suspension link arrangement 26 or a lower suspension link arrangement 28, or both, can include respective upper inner 30ui and upper outer 32uo suspension arms or links and/or lower inner 30li and lower outer 3010 suspension link arms.

Pairs of upper and lower suspension link arrangements can be provided in embodiments for up and down parallel motion of the respective pivot hub 22 whilst maintaining the correct ground engaging means orientation relative to the ground and for steering accuracy and mobile platform/vehicle stability.

The respective pivot hub 22 enables rotation of the associate ground engaging means 16 about a vertical axis for steering/direction control of the mobile platform/vehicle 10. The respective pivot hub 22 can include drive means 34 to power rotation about the respective upright/vertical pivot axis.

Payload can be selectively dispensed through at least one dispensing outlet 36 provided underneath the support structure/chassis 12. For example, in embodiments transporting and dispensing explosive, such as ANFO, controlled dispensing of the explosive can be through the at least one dispensing outlet 36. It will be appreciated that the mobile platform/vehicle 10 can straddle a drill/blast hole to dispense the explosive (or other payload-such as lowering a sensing instrument into the drill/blast hole).

Coarse/gross positioning of the mobile platform or vehicle 10 can be autonomous, semi-autonomous or guided (such as by an operator having an umbilical electrical control connection to the mobile platform or vehicle), such that the operator is able to remain at a safe distance during transport and/or dispensing of the payload.

Coarse/gross positioning can include the mobile platform/vehicle travelling over the ground surface or the terrain (e.g. contoured topography or uneven terrain, such as having ground elevations and depressions, being rocky and/or being shelving ground), negotiating any obstacles, holes, rocks, slopes and gradients by operation of the suspension whilst maintaining the load level as desired.

Mobile platform/vehicle positioning can be provided by the ability of the mobile platform/vehicle to rotate the ground engaging means about the vertical pivot axes such that the payload container can be moved forwards-backwards, sideways (left-right) at 90° to forward-backward, or any angle between forward-backward and 90° sideways.

The rotation of the ground engaging means about the respective vertical axes enables diagonal ‘crabbing’ motion to enhance fine positioning or coarse steering, and accurate ‘over the hole’ positioning.

Embodiments include at least one hole identification system 70 (such as at least one hole perception system), such as to identify position or location of a hole or that the object perceived is a hole. The at least one hole identification/hole perception system may include at least one imaging means or image capture device 72, such as at least one camera.

Embodiments of the at least one hole identification/hole perception system 70 can include multiple image capture devices 72.

Embodiments may include a stereo camera arrangement. Embodiments can have a stereo camera arrangement, such as with two lenses, preferably with a separate image sensor for each camera/lens or a single sensor for capturing images side by side from each lens, to simulate human binocular vision to capture three-dimensional images.

The at least one hole identification/perception system may include a processor arranged and configured to calculate distance (D₁, D₂) from a reference (such as from a stereo camera arrangement) to one or more points on the hole.

Preferably, height from the ground at or adjacent the hole is determined or known. For example, height (H) of an image capture device, such as a camera/stereo camera arrangement, can be used with geometry to determine/calculate horizontal distance (L) from image capture device/camera to the specific point. For example, the specific point may be the near edge of the hole to the image capture device(s).

Embodiments may employ part of the full captured image as the search area for identifying the hole 58. For example, a central portion of the captured image of the hole may be used as the search area.

The size of the search area, as influenced by the height (H) and angle of the at least one image capture device (such as a camera) relative to the hole, may be predetermined. For example, preferably the at least one image capture device may be provided about 1 metre from the ground surface with an image capture area of 1.2 m×1.2 m, which may be divided into sub regions of the respective image to identify presence of a hole in each sub region.

Variance for each of the sub regions of interest is preferably determined to assess whether any particular sub region contains an image of the hole. If there are no holes identified in a sub region, then the variance of that sub region is given a value, say 200-500, but if there are one or more holes identified in the particular sub region, the respective variance will be above a threshold value, say, 1000 or more.

Embodiments may include limiting/putting a range on, the minimum or maximum distance from/to the hole, may compare against an expected hole size (e.g. diameter), or compare with other images from other cameras, or compare to a reference hole image.

Embodiments may allow for the ground surface being at an angle relative to the at least one image capture device—e.g. options i, ii, and iii in FIG. 2C. For example, the ground surface into which the hole extends may be horizontal or may be on a slope, sloping upwards and away from the at least one image capture device (iii, FIG. 2C), or sloping downwards and away from the image capture device (i, FIG. 2C). The image capture device may be at an angle relative to horizontal ground surface (ii, FIG. 2C).

Other angles are considered to fall within the scope of the capability of embodiments of the present invention. By way of example, for a horizontal image capture device viewing directly downwards, different topographies will be observed depending on the levelness or slope of the ground surface around the hole—see i, ii and iii, FIG. 2B. However, if the image capture device is angled for non-vertical imaging (e.g. oblique to the ground plane), a similar image may result regardless of levelness or slope of the ground surface—e.g. see i, ii and iii, FIG. 2C.

Embodiments include identifying in captured image data a point at an edge of the hole to be identified—e.g. see FIG. 2D. Embodiments may include finding two points (e.g. P₁, P₂) within the image data where the difference in distance from the image capture device to each of two points of interest are a maximum for the image data. For example, a first point P₁ in image data may represent a nearest point of a potential hole to be identified (candidate point). Beyond (above, for example, in the image) that point P₁, distance changes suddenly to a second point, P₂ say, representing the far side internal hole wall within the hole. The hole identification system can determine e.g. measure, distances to the first point (P₁ say) and the second point (P₂ say), and if the first point is the most ideal point of the image data, the difference in distance (e.g. D₂-D₁) between P₁ and P₂ from the image capture device 72 is preferably the biggest within the region of interest in the image data.

Colour or greyscale can be used in image data to represent distance. For example, different colours or shades of grey may be used to represent the distance from image capture device to the respective point of interest. The ‘best’ point of interest that is most likely to represent an edge of a hole is where the distance data (changes the most within the data set) has the largest large distance change and/or contrast change.

After identifying the most suitable candidate point as the edge of a hole, a search in the image data of the points beyond the best candidate point can be conducted checking for the different in distance reducing, and in ideal situation, the point is totally same as other points thereby identifying the opposite edge of the hole. Thereby confirming that a hole is present in the image data.

During motion and/or once positioned over the blast/drill hole to release payload 54 into the blast/drill hole 58, the mobile platform or vehicle 10 can ensure that the load is level even on contoured ground, such as a gradient or cross-slope, by adjusting the height of each suspension arrangement as required in relation to the ground height under each ground engaging means. Payload is dispensed correctly (e.g. directly downward) even while the ground is sloping or uneven.

Embodiments include fine positioning of a delivery outlet 37 over the opening of the hole. Embodiments may include a fine positioning arrangement/system 33 for fine positioning of a delivery outlet 37 over the opening of the hole. Embodiments can include a delivery outlet adjustment means 39, which may include at least one fine positioning actuator (e.g. one or more motors, linear actuators, rams, cable/wire operated adjusters).

Fine positioning can include control of up-down motion and/or lateral motion/positioning of the delivery outlet 37. Delivery of the material from the container/hopper 14 can be through the dispensing outlet 36 to a delivery conduit 110, such as a tube, funnel or chute.

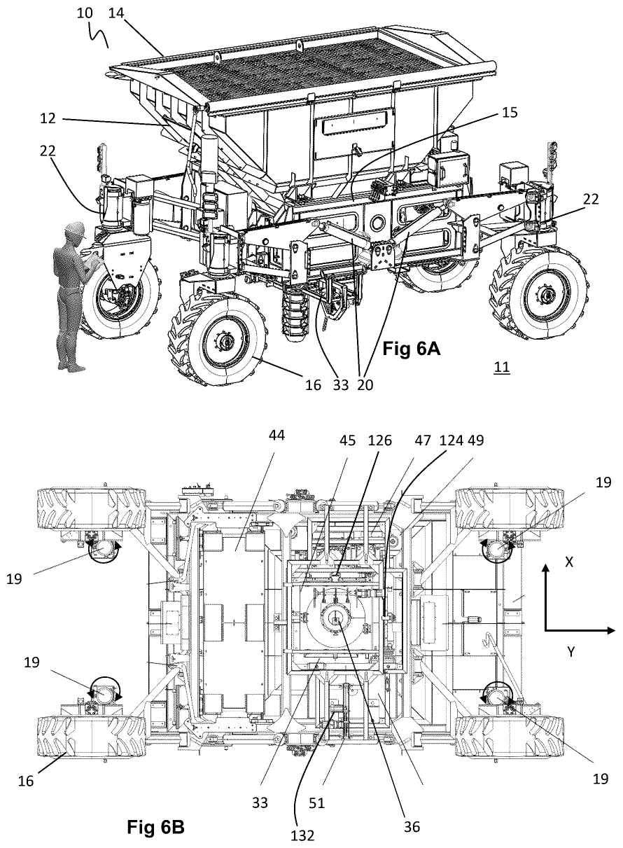

Height adjustment of a distal end 37A of the delivery outlet can be controlled, such as by a height actuator 112 (e.g. an electric motor). Lateral fine positioning of the distal end of the delivery outlet can be provided by one or more lateral actuators 114 (e.g. rams, cylinders). See, for example, FIG. 7. It will be appreciated that a proximal end 37B of the delivery outlet can be mounted to the vehicle/mobile platform at a pivot connection 116, such as a universal joint or multiple pivot joints, enabling up-down and side-to-side motion of the delivery outlet.

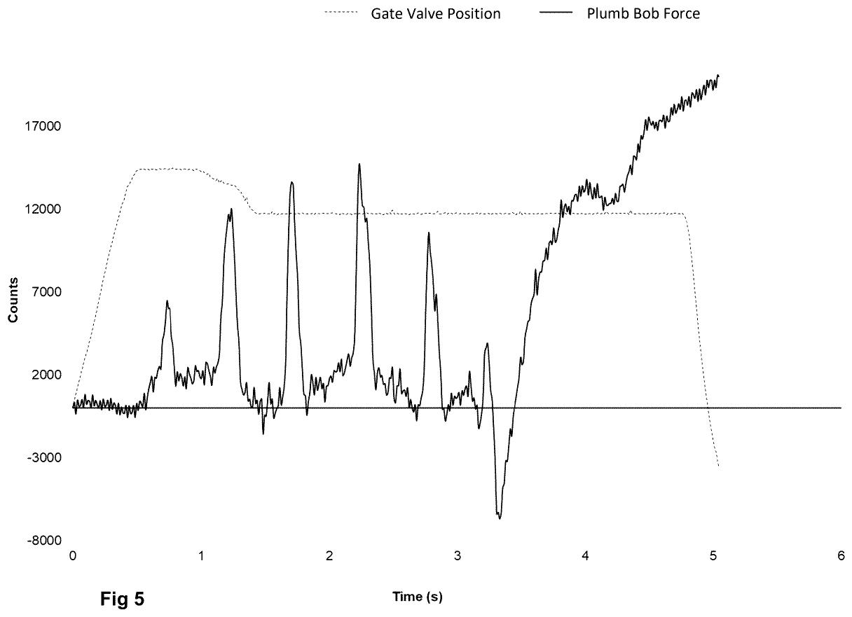

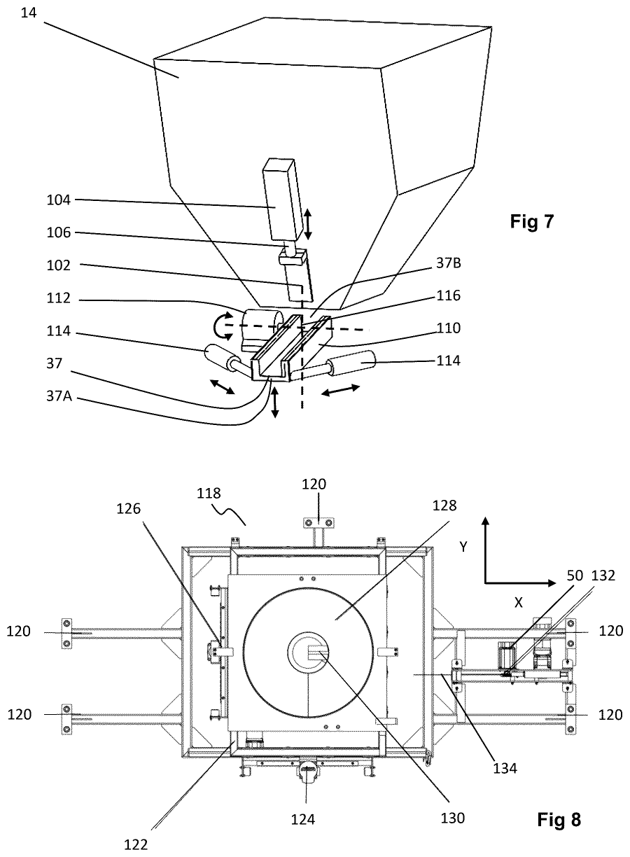

Fine positioning of the delivery outlet 37 can be provided by at least one position control arrangement 118, such as acting along horizontal X and Y axes. For example, a first motor driven rack and pinion assembly 124 can provide X axis positioning and a second motor driven rack and pinion assembly 126 can provide Y axis positioning. X axis can be defined as being aligned lateral/transverse across the vehicle and the Y axis can be defined as being longitudinal along the vehicle—see for example FIGS. 6B and 8. Fixing points 120 can be provided to mount the positioning control system to the vehicle's chassis/structure. A frame 122, such as a rolling frame, can be provided for the delivery outlet to be supported by for such fine positioning over the hole to receive the payload. The delivery outlet can include a chute or funnel 128.

A dipping line spout 130 can be provided for guiding a dipping line 134 from a dipping system 132, such as from a winch 56 for paying out and winding in the probe 50.

Lateral motion can be controlled by cables attached to respective motors to move the delivery outlet side-to-side for fine lateral positioning. Height and lateral positioning can be controlled by the on-board processer and/or remote control, such as by autonomous or remote use of the identification system and/or an additional perception system e.g. one or more imaging devices or distance measuring devices arranged to operate underneath the support platform.

### 42

Power systems, such as a hydraulic system can be provided in a compartment 40 on/in the payload support structure/chassis 12. In the case of hydraulic suspension, the suspension arrangement can include one or more suspension accumulators 41 to store/absorb/return hydraulic pressure.

Electric power can be provided by one or more on-board batteries, which may be retained in a battery compartment 44, preferably with safety protection (such as a fire/heat shield 42) separating the batteries from the container and payload.

Electric control systems, such as for guidance, GPS, sensing and power control can be provided in one or more control compartments/boxes 46.

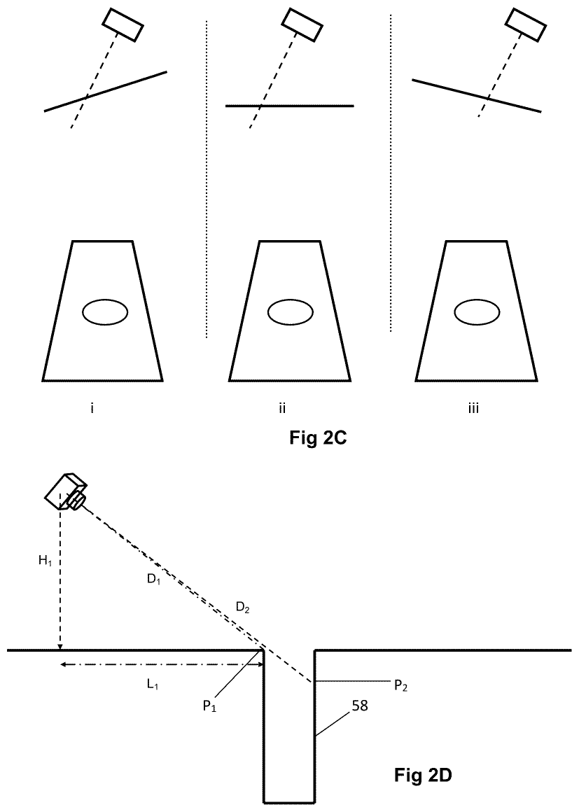

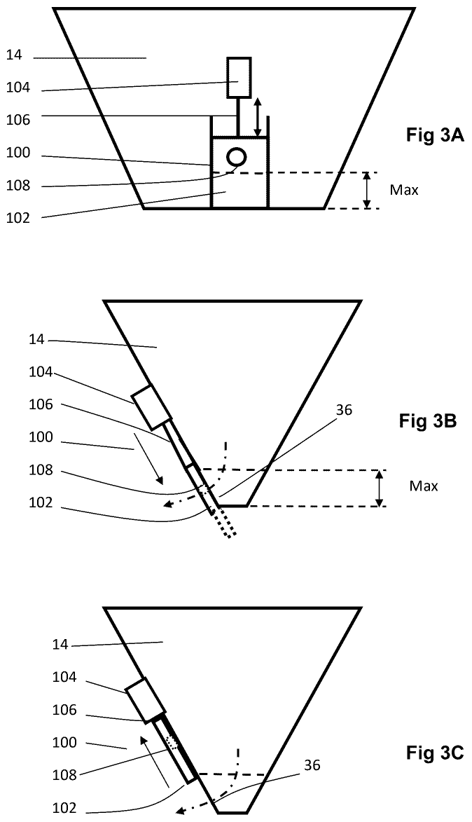

An outlet valve 100 can include a gate 102, and actuator 104 (e.g. pneumatic, electric or hydraulic linear actuator), and a linkage 106 connecting the actuator and the gate. In a closed position of the outlet valve (FIG. 3A), payload material is retained within the container 14 (e.g. hopper). In a fully open position of the outlet valve 100 (FIG. 3C), the maximum flow rate of payload material can be dispensed through an outlet 36 of the container 14. A restricted outlet 108 can be selected to reduce flow of payload material for fine delivery control. It will be appreciated that the outlet valve can be controlled remotely or can be controlled autonomously by the mobile platform/vehicle following a pre-programmed payload delivery plan.

Alternatively, the outlet valve 100 can include one or more pivotable door 103. Preferably, the outlet valve 100 can include co-operating doors 103a, 103b, such as a clamshell arrangement (e.g. see FIG. 3D1 to 3E). an actuator 104, such as a hydraulic or pneumatic ram, can be actuated to selectively control opening and closing. The doors 103a, 103b can include inter-engagement portions 105a, 105b, such as by a toothed engagement, and pivots 107, such that operation of one door causes the other door to operate simultaneously such that the doors open and close in concert e.g. in a clamshell type mechanism.

Embodiments may include a hole depth measurement arrangement 51, which may include a dipping winch 56 and deployable dipping probe 50.

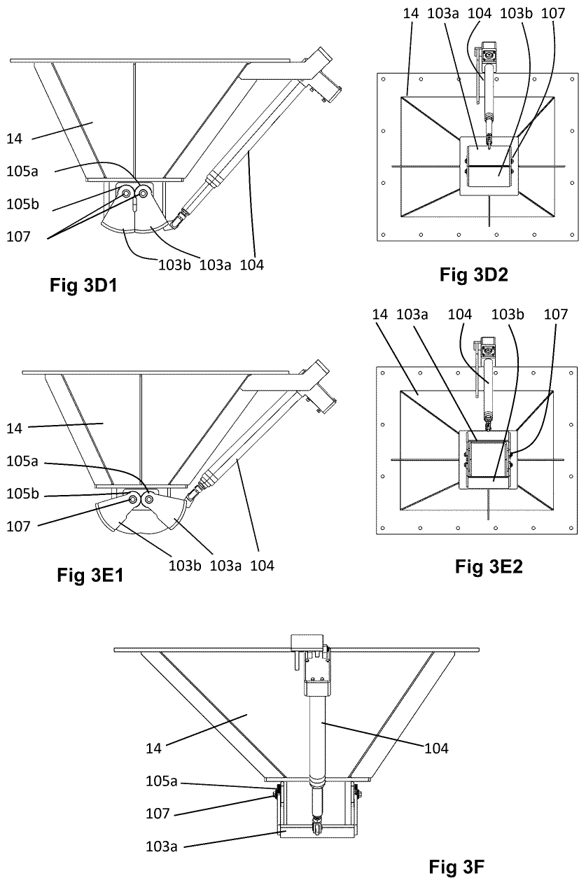

Preferably, the operator uses remote (tele) monitoring to obtain confirmation to load the payload 54 into the hole. The outlet valve 100 is remotely controlled to open and dispense the payload 54. A dipping probe (weight/mass) 50 can be deployed suspended from the flexible elongate member 52 of a winch 56 to the cavity detection height within the blast hole 58 (see FIGS. 4A and 4B).

Force F₁ on the dipping probe 50 can be detected, such as by measuring tension or change in tension (e.g. as a force F₃) in a flexible elongate member 52, such as a cable, as the payload flows over the probe during dispensing of the payload into the hole 58. When the payload e.g. the dispensed explosive, dispensed into the hole reaches the level of the probe, a buoyancy force F₂ can be detected through change in tension in the elongate flexible member.

A detonator immersion check can be conducted by comparing quantity of dispensed payload 54 to the expected quantity 1 m from bottom of the hole—if the first metre has filled quicker or slower than expected for the depth and diameter of the hole 58, this indicates there may be a cavity where payload material 54 is seeping or a collapse that could result in the payload material not reaching the detonator and potentially resulting in a misfire.

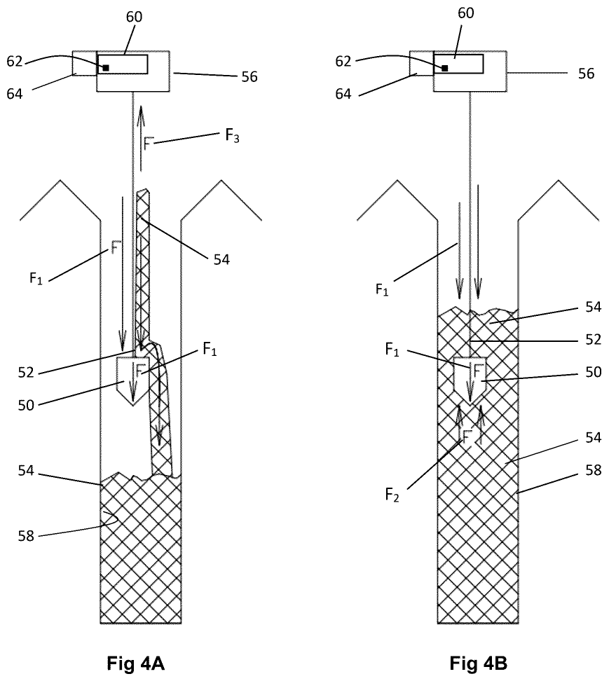

The probe (weight/mass) 50 on the flexible elongate member suspended 52 by the winch 56 is raised to stemming height within the hole as flow of the payload 54 continues (assuming an error was not detected prior). If immersion detected: the dipping winch 56 detects a change in tension of the flexible elongate member 52—e.g. measured with a load cell 62 attached to a pulley 60 and/or with a tension arm, which is connected to a servo motor 64 with a configurable torque limit. See, for example, FIG. 5 showing a chart of force (N) versus Time(s) representing outlet valve open-closed position (broken line: 0 force=fully closed; max 15,000 N fully open) and load (force) on the dipping winch weight/mass/probe (solid line) in determining load dispensed from a mobile platform/vehicle according to a further embodiment of the present invention. The outlet valve 100 is then closed once the mass/weight 50 at the end of the winch elongate flexible member 52 is detected as being immersed in the payload material 54 delivered into the hole 58. Alternatively, If the dipping winch 56 has not detected immersion of the mass/weight 50 once the target loadout payload material 54 volume/mass has been detected, the outlet valve 100 is closed and the operator alerted to a variance error.

Dipping winch ‘touched off’: If there was not a time out-the dipping winch 56 retracts the mass/weight 50 until it is no longer immersed in the delivered payload material 54. The dipping winch 56 can then be used to touch the mass/weight 50 on the top of the material 54 in the filled hole 58 to record the final stemming height. Dipping winch weight/mass 50 can then be retracted to its retracted (storage) position. The fine positioning system 37 can then retract the delivery chute/tube outlet 39 to a ‘home’ retracted position. Payload 54 mass/volume delivered to the hole 58, fill time taken and depth are preferably logged to a database/record.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus including a mobile platform for transporting and/or delivering a payload across a ground surface or terrain to a drilled hole or blast hole, the mobile platform including a payload support structure, a plurality of ground engaging means for traversing the ground surface or the terrain, and a suspension arrangement supporting the payload support structure on the plurality of ground engaging means, and wherein the apparatus includes at least one of hole identification system configured to identify location of the drilled/blast hole and/or includes at least one payload delivery arrangement for controlling delivery of payload material from the payload support structure into the drilled/blast hole.

2. The apparatus of claim 1, wherein the mobile platform includes a remotely controlled vehicle or an autonomous vehicle, or a vehicle controllable to be remotely changed from autonomous operation to tele-operation or vice-versa.

3. The apparatus of claim 1, including at least one controllable outlet means configured to control dispensing rate and/or dispensing mass/volume of the payload material into the drilled/blast hole.

4. The apparatus of claim 3, wherein the at least one controllable outlet means includes at least one of a variable size opening, a valve, a hatch, a shutter, openable chute, one or more doors, a clamshell type door arrangement, an auger, a screw feeder/dispenser, a vibratory screw feeder/dispenser, pneumatic, hydraulic or electric actuated valve, a pneumatic, hydraulic or electric actuated door or gate, a slide valve, or a combination of any two or more thereof.

5. The apparatus of claim 3, wherein the at least one controllable outlet means includes a variable orifice outlet and/or one or more selectable outlets of differing opening dimensions.

6. The apparatus of claim 1, including the at least one hole identification system having at least one perception system arranged and configured to obtain data relating to location, shape, state or angle of the hole, or a combination of any two or more thereof.

7. The apparatus of claim 6, wherein the perception system includes at least one image capture device and/or at least one distance and ranging system, the respective system providing respective contrast or distance data.

8. The apparatus of claim 7, the at least one hole identification system including a stereoscopic camera arrangement, a lidar system, a radar system or a colour or grey scale contrast analyser, or a combination of any two or more thereof.

9. The apparatus of claim 6, wherein the at least one hole identification system includes at least one processor arranged and configured to calculate distance from a reference to one or more points on the drilled/blast hole.

10. The apparatus of claim 9, wherein the at least one processor is configured to determine distance from the reference to a point on an edge of an opening of the drilled/blast hole to the reference.

11. The apparatus of claim 6, wherein the at least one hole identification system is configured to identify two points within data relating to the hole where the difference in distance from the at least one image capture device to each of two points of interest are a maximum for the data.

12. The apparatus of claim 11, wherein a first point in the data relating to the hole represents a nearest point or candidate point of a potential hole to be identified.

13. The apparatus of claim 11, wherein, beyond the first point, distance changes suddenly to a second point, representing a far side internal hole wall within the drilled/blast hole, wherein difference in distance between the first point and the second point is the largest difference within the region of interest in the image data and the first point is determined to be the most suitable candidate point being at the edge of the drilled/blast hole.

14. The apparatus of claim 13, wherein data points beyond the best candidate point represent the difference in distance reducing.

15. The apparatus of claim 1, wherein the payload support structure includes a container or hopper for holding explosive or stemming as the payload material.

16. The apparatus of claim 1, including a hole depth measurement arrangement.

17. The apparatus of claim 16, wherein the hole depth measurement arrangement includes a winch having a flexible elongate member supporting a weight/mass for lowering into the drilled/blast hole.

18. The apparatus of claim 17, wherein the hole depth measurement arrangement includes at least one load sensor or torque arm to sense change in tension in the flexible elongate member.

19. The apparatus of claim 18, wherein the change in tension is an indicator that the weight/mass has reached hole bottom, reached an obstruction, or has reached water level in the hole.

20. The apparatus of claim 18, wherein a reduction in the tension is detected indicating that the probe, weight or mass has become immersed/submersed in the payload material dispensed into the drilled/blast hole.

21. The apparatus of claim 1, including a position controllable outlet to direct the dispensed payload material into the opening of the drilled/blast hole.

22. The apparatus of claim 21, wherein the position controllable outlet includes a guide, a channel, a chute, a flexible chute and/or a funnel below the outlet valve.

23. The apparatus of claim 22, wherein a dispensing position of the position controllable outlet is controlled by one or more positioning actuators.

24. The apparatus of claim 23, wherein the one or more positioning actuators includes one or more rotary actuator, one or more linear actuator, one or more pneumatic, electric or hydraulic actuators, one or more winches, one or more motors, one or more cylinders or rams, or a combination of any two or more thereof.

25. The apparatus of claim 24, wherein the one or more positioning actuators is/are controlled to position the position controllable outlet automatically/autonomously via processor control, or to position the position controllable outlet via operator controlled tele-remote interface.

26. The apparatus of claim 1, wherein the mobile platform or vehicle is arranged and configured to straddle the hole for dispensing the payload material.

27. The apparatus of claim 26, wherein the mobile platform or vehicle is configured to dispense the payload material whilst positioned over the hole.

28. The apparatus of claim 1, including a timer providing a timing signal for timing dispensing of the payload material.

29. The apparatus of claim 28, wherein, if expected dispensing time period elapses but the expected mass/weight/volume of the payload material dispensed or a mass/weight/volume thereof has not been reached, or if the probe is not immersed in the dispensed payload material in the hole, a fault, error or alert is initiated.

30. The apparatus of claim 28, wherein the timing signal is initiated onboard the mobile platform or vehicle or is provided from a remote location to the mobile platform or vehicle.
